(19) United States
(12) Patent Application Publication
(10) Pub. No.: US 2025/0078243 A1
(43) Pub. Date: Mar. 6, 2025

(54) SYSTEM AND METHOD FOR SCANNING THE EXTERIOR OF A VEHICLE, COMPUTER-READABLE STORAGE MEDIUM

(71) Applicant: HL MANDO CORPORATION, Pyeongtaek-si (KR)

(72) Inventor: JiHyun LEE, Pyeongtaek-si (KR)

(73) Assignee: HL MANDO CORPORATION, Pyeongtaek-si (KR)

(21) Appl. No.: 18/818,752

(22) Filed: Aug. 29, 2024

(30) Foreign Application Priority Data
Sep. 1, 2023 (KR) 10-2023-0116361
Aug. 22, 2024 (KR) 10-2024-0112632

(51) Int. Cl. G06T 7/00; G01S 17/89; G06T 7/70; G06V 10/141; G06V 20/62

(52) U.S. Cl. CPC G06T 7/0004; G01S 17/89; G06T 7/70; G06V 10/141; G06V 20/625; G06T 2207/30252

(57) ABSTRACT

A system and method for scanning the exterior of a vehicle, and a computer-readable storage medium storing a program for performing the method are disclosed. The system for scanning the exterior of a vehicle according to one embodiment of the present disclosure includes a support structure that is disposed so that the vehicle enters a front thereof and exits a rear thereof and includes a left support portion, a right support portion, and an upper support portion, a vehicle position detection device including one or more sensors for detecting a position of the vehicle entering the front of the support structure or exiting the rear of the support structure, a left photographing device disposed on the left support portion to photograph the vehicle, a right photographing device disposed on the right support portion to photograph the vehicle, an upper photographing device disposed on the upper support portion to photograph the vehicle, and a controller configured to control the left photographing device, the right photographing device, and the upper photographing device based on detection information from the vehicle position detection device to acquire plurality of vehicle exterior images.

### CROSS-REFERENCE TO RELATED APPLICATIONS

This application claims priority to and benefit from Korean Patent Application No. 10-2023-0116361, filed on Sep. 1, 2023, and Korean Patent Application No. 10-2024-0112632, filed on Aug. 22, 2024, the disclosures of which are incorporated herein by reference in their entireties.

### TECHNICAL FIELD

The present disclosure relates to a system and method for scanning the exterior of a vehicle and a computer-readable storage medium, and more particularly, to a system and method for scanning the exterior of a vehicle for obtaining an image of the exterior of the vehicle, and a computer-readable storage medium storing a program for performing the method.

### RELATED ART

When providing car rental services, car sharing services, and the like, it is necessary to accurately ascertain information about the exterior of a vehicle before and after providing the services. When damage to the exterior of the vehicle is discovered through the ascertained information, a clear determination as to whether the damage is the responsibility of a user using the vehicle through the services may be made, and unnecessary disputes may be prevented.

However, in car rental services, car sharing services, and the like, detection of damage to the exterior of a vehicle is still performed by the naked eye or by directly photographing the vehicle by a user before or after use. Therefore, there is a need for the development of technology of automatically scanning the exterior of a vehicle so that an accurate determination as to whether the exterior of the vehicle is damaged may be made.

### SUMMARY

The present disclosure is directed to providing a system and method for scanning the exterior of a vehicle that automatically acquire a plurality of vehicle exterior images during an entering or exiting process for a vehicle, and a computer-readable storage medium storing a program for performing the method.

The present disclosure is also directed to providing a system and method for scanning the exterior of a vehicle that automatically determine whether the exterior of a vehicle is damaged when the vehicle enters or exits, and a computer-readable storage medium storing a program for performing the method.

The objects of the present disclosure are not limited to the above-described objects, and other objects that are not mentioned will be able to be clearly understood by those skilled in the art to which the present disclosure pertains from the following description.

According to one aspect of the present disclosure, there is provided a system for scanning an exterior of a vehicle including a support structure that is disposed so that the vehicle enters a front thereof and exits a rear thereof and that includes a left support portion vertically extending on a left side based on a direction of travel of the vehicle, a right support portion vertically extending on a right side based on the direction of travel of the vehicle, and an upper support portion supported by the left support portion and the right support portion on an upper side of the vehicle and extending in a left-right direction, a vehicle position detection device including one or more sensors for detecting a position of the vehicle entering the front of the support structure or exiting the rear of the support structure, a left photographing device disposed on the left support portion to photograph the vehicle, a right photographing device disposed on the right support portion to photograph the vehicle, an upper photographing device disposed on the upper support portion to photograph the vehicle, and a controller configured to control the left photographing device, the right photographing device, and the upper photographing device based on detection information from the vehicle position detection device to acquire a plurality of vehicle exterior images.

In the system for scanning an exterior of a vehicle according to one embodiment of the present disclosure, the controller may determine whether the exterior of the vehicle is damaged by analyzing the plurality of vehicle exterior images.

In the system for scanning an exterior of a vehicle according to one embodiment of the present disclosure, the left photographing device may include a first left camera disposed to face a front left side based on the support structure, a second left camera disposed to face the right support portion, and a third left camera disposed to face a rear left side based on the support structure.

In the system for scanning an exterior of a vehicle according to one embodiment of the present disclosure, the right photographing device may include a first right camera disposed to face a front right side based on the support structure, a second right camera disposed to face the left support portion, and a third right camera disposed to face a rear right side based on the support structure.

In the system for scanning an exterior of a vehicle according to one embodiment of the present disclosure, the upper photographing device may include a first upper camera disposed to face a front lower side based on the support structure, a second upper camera disposed to face a vertical lower side, and a third upper camera disposed to face a rear lower side based on the support structure.

In the system for scanning an exterior of a vehicle according to one embodiment of the present disclosure, the controller may be configured to determine the position of the vehicle based on the detection information from the vehicle position detection device while the vehicle enters the support structure from the front of the support structure and exits the rear of the support structure, and operate the left photographing device depending on the position of the vehicle to acquire a left front image of the vehicle, a front left side image of the vehicle, a rear left side image of the vehicle, or a left rear image of the vehicle.

In the system for scanning an exterior of a vehicle according to one embodiment of the present disclosure, the controller may be configured to determine the position of the vehicle based on the detection information from the vehicle position detection device while the vehicle enters the support structure from the front of the support structure and exits the rear of the support structure and operate the right photographing device depending on the position of the vehicle to acquire a right front image of the vehicle, a front right side image of the vehicle, a rear right side image of the vehicle, or a right rear image of the vehicle.

In the system for scanning an exterior of a vehicle according to one embodiment of the present disclosure, the controller may be configured to determine the position of the vehicle based on the detection information from the vehicle position detection device while the vehicle enters the support structure from the front of the support structure and exits the rear of the support structure and operate the upper photographing device depending on the position of the vehicle to acquire a front upper image of the vehicle or a rear upper image of the vehicle.

In the system for scanning an exterior of a vehicle according to one embodiment of the present disclosure, the controller may operate the upper photographing device depending on the position of the vehicle to further acquire a front image of the vehicle or a rear image of the vehicle.

In the system for scanning an exterior of a vehicle according to one embodiment of the present disclosure, the controller may operate the upper photographing device depending on the position of the vehicle to further acquire a middle upper image of the vehicle.

In the system for scanning an exterior of a vehicle according to one embodiment of the present disclosure, the vehicle position detection device may include a light sensor configured to detect emitted light.

In the system for scanning an exterior of a vehicle according to one embodiment of the present disclosure, the vehicle position detection device may include a lidar sensor disposed on the upper support portion of the support structure.

In the system for scanning an exterior of a vehicle according to one embodiment of the present disclosure, the controller may operate one or more of the left photographing device, the right photographing device, or the upper photographing device at a point in time when it is determined that the vehicle reaches each of a first position where the vehicle is separated in front of the support structure, a second position between the first position and the support structure, a third position between the second position and the support structure, a fourth position separated in the rear of the support structure, or a fifth position separated further rearward from the support structure than the fourth position based on the detection information from the vehicle position detection device.

In the system for scanning an exterior of a vehicle according to one embodiment of the present disclosure, the controller may operate one or more of the left photographing device, the right photographing device, or the upper photographing device at a point in time when it is determined that the vehicle passes each of a first position separated in front of the support structure, a second position between the first position and the support structure, a third position between the second position and the support structure, a fourth position separated in the rear of the support structure, or a fifth position separated further rearward from the support structure than the fourth position based on the detection information from the vehicle position detection device.

The system for scanning an exterior of a vehicle according to one embodiment of the present disclosure may further include one or more lighting devices disposed on the support structure to emit lighting light.

The system for scanning an exterior of a vehicle according to one embodiment of the present disclosure may further include a vehicle number recognition device configured to recognize a vehicle number written on a license plate of the vehicle.

According to another aspect of the present disclosure, there is provided a method of scanning an exterior of a vehicle, including detecting a vehicle entering a position separated in front of a support structure, acquiring a plurality of vehicle exterior images while the vehicle proceeds by entering a front of the support structure and exiting a rear, and determining whether the exterior of the vehicle is damaged by analyzing the plurality of vehicle exterior images.

In the method of scanning an exterior of a vehicle according to the another aspect of the present disclosure, the acquiring of the plurality of vehicle exterior images may include acquiring a front image of the vehicle at a point in time when the vehicle reaches a first position separated in front of the support structure, acquiring a left front image of the vehicle and a right front image of the vehicle at a point in time when the vehicle reaches a second position between the first position and the support structure, acquiring a front upper image of the vehicle at a point in time when the vehicle reaches a third position between the second position and the support structure, acquiring a front left side image of the vehicle and a front right side image of the vehicle at a point in time when the vehicle reaches a fourth position separated in the rear of the support structure, and acquiring a middle upper image of the vehicle at a point in time when the vehicle reaches a fifth position separated further rearward from the support structure than the fourth position.

In the method of scanning an exterior of a vehicle according to the another aspect of the present disclosure, the acquiring of the plurality of vehicle exterior images may further include acquiring a rear left side image of the vehicle and a rear right side image of the vehicle at a point in time when the vehicle passes the second position, acquiring a rear upper image of the vehicle at a point in time when the vehicle passes the third position, acquiring a rear left side image of the vehicle and a rear right side image of the vehicle at a point in time when the vehicle passes the fourth position, and acquiring a rear image of the vehicle at a point in time when the vehicle passes the fifth position.

According to still another aspect of the present disclosure, there is provided a non-transitory computer-readable storage medium storing one or more instructions for performing a method of scanning an exterior of a vehicle, the method including detecting a vehicle entering a position separated in front of a support structure, acquiring a plurality of vehicle exterior images while the vehicle proceeds by entering a front of the support structure and exiting a rear, and determining whether the exterior of the vehicle is damaged by analyzing the plurality of vehicle exterior images.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating a configuration of a system for scanning the exterior of a vehicle (vehicle exterior scanning system) according to one embodiment of the present disclosure from the front;

FIG. 2 is a view illustrating the configuration of the vehicle exterior scanning system according to one embodiment of the present disclosure from the rear;

FIG. 3 is a view illustrating a left photographing device or a right photographing device of a support structure of a vehicle exterior scanning system according to one embodiment of the present disclosure;

FIG. 4 is a view illustrating an upper photographing device of a support structure of a vehicle exterior scanning system according to one embodiment of the present disclosure;

FIG. 5 is a view illustrating acquisition of a vehicle front image by the vehicle exterior scanning system according to one embodiment of the present disclosure;

FIG. 6 is a view illustrating acquisition of a vehicle left front image and a vehicle right front image by a vehicle exterior scanning system according to one embodiment of the present disclosure;

FIG. 7 is a view illustrating acquisition of a vehicle front upper image by the vehicle exterior scanning system according to one embodiment of the present disclosure;

FIG. 8 is a view illustrating acquisition of a vehicle front left side image and a vehicle front right side image by the vehicle exterior scanning system according to one embodiment of the present disclosure;

FIG. 9 is a view illustrating acquisition of a vehicle middle upper image by the vehicle exterior scanning system according to one embodiment of the present disclosure;

FIG. 10 is a view illustrating acquisition of a vehicle rear left side image and a vehicle rear right side image by the vehicle exterior scanning system according to one embodiment of the present disclosure;

FIG. 11 is a view illustrating acquisition of a vehicle rear upper image by the vehicle exterior scanning system according to one embodiment of the present disclosure;

FIG. 12 is a view illustrating acquisition of a vehicle left rear image and a vehicle right rear image by the vehicle exterior scanning system according to one embodiment of the present disclosure;

FIG. 13 is a view illustrating acquisition of a vehicle rear image by a vehicle exterior scanning system according to one embodiment of the present disclosure;

FIG. 14 is a view illustrating another example of a vehicle position detection device of a vehicle exterior scanning system according to one embodiment of the present disclosure;

FIG. 15 illustrates a state in which vehicle position detection is performed when the vehicle position detection device of the vehicle exterior scanning system according to one embodiment of the present disclosure is configured as shown in FIG. 14;

FIG. 16 is a flowchart of a method of scanning an exterior of a vehicle according to one embodiment of the present disclosure; and

FIG. 17 is a flowchart of an operation of acquiring a plurality of vehicle exterior images in the method of scanning an exterior of a vehicle according to one embodiment of the present disclosure.

### DETAILED DESCRIPTION OF EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

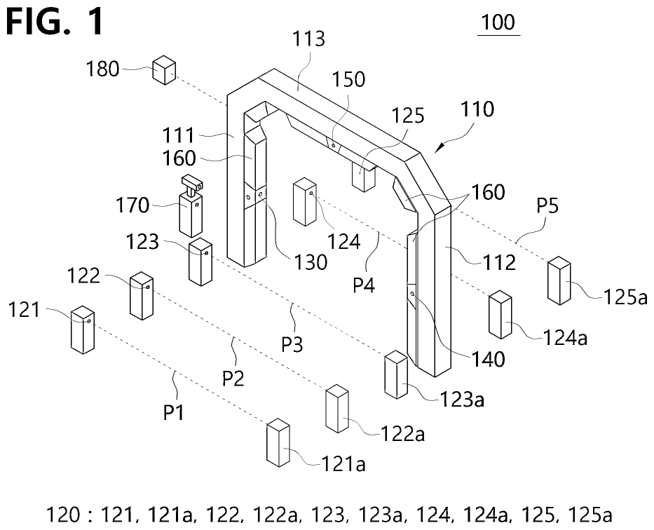

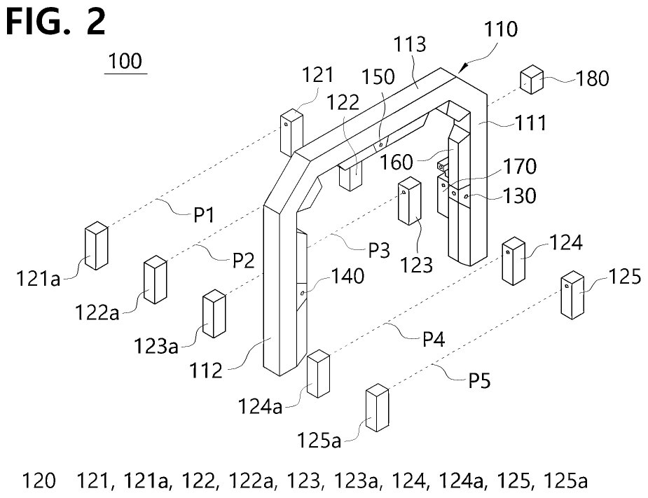

FIG. 1 is a view illustrating a configuration of a system for scanning the exterior of a vehicle (vehicle exterior scanning system) according to one embodiment of the present disclosure from the front. FIG. 2 is a view illustrating the configuration of the vehicle exterior scanning system according to one embodiment of the present disclosure from the rear.

A vehicle exterior scanning system 100 according to one embodiment of the present disclosure automatically acquires a plurality of vehicle exterior images that allow a determination as to whether the exterior of the vehicle is damaged to be made. In addition, the vehicle exterior scanning system 100 may determine whether the exterior of the vehicle is damaged using a plurality of vehicle exterior images.

For example, the vehicle exterior scanning system 100 may be disposed at an entrance of a parking lot and automatically acquire a plurality of images of the exterior of a vehicle entering or exiting the parking lot. In this case, the vehicle may be used for a car rental service or a car sharing service.

Referring to FIGS. 1 and 2, the vehicle exterior scanning system 100 according to one embodiment of the present disclosure includes a support structure 110, a vehicle position detection device 120, a left photographing device 130, a right photographing device 140, an upper photographing device 150, a lighting device 160, a vehicle number recognition device 170, and a controller 180.

The support structure 110 is disposed so that the vehicle enters the front thereof and exits the rear thereof. The support structure 110 may have an inverted U-shape or an arch shape that allows entry and exit of vehicles.

The support structure 110 includes a left support portion 111, a right support portion 112, and an upper support portion 113. The left support portion 111 vertically extends on the left side based on a direction of travel of the vehicle. The right support portion 112 vertically extends on the right side based on the direction of travel of the vehicle. The upper support portion 113 is supported by the left support portion 111 and the right support portion 112 on the upper side of the vehicle and extends in a left and right direction.

The left support portion 111 and the right support portion 112 are disposed side by side with a distance greater than the width of the vehicle. In addition, the left support portion 111 and the right support portion 112 have a height greater than the height of the vehicle. Left and right ends of the upper support portion 113 may be formed to be inclined downward toward an upper end of the left support portion 111 and an upper end of the right support portion 112, respectively.

The vehicle position detection device 120 detects the position of a vehicle entering the front of the support structure 110 or exiting the rear of the support structure 110. The vehicle position detection device 120 may include one or more sensors.

In one embodiment of the present disclosure, the vehicle position detection device 120 may detect whether a vehicle enters or passes at a first position P1 separated in front of the support structure 110, a second position P2 between the first position P1 and the support structure 110, a third position P3 between the second position P2 and the support structure 110, a fourth position P4 separated in the rear of the support structure 110, and a fifth position P5 separated further rearward from the support structure 110 than the fourth position P4.

Here, entry of the vehicle means that the front end of the vehicle reaches a corresponding position. In addition, passage of the vehicle means that the rear end of the vehicle passes the corresponding position.

The vehicle position detection device 120 may include a light sensor that detects light that is emitted. In this case, the light may be emitted transversely across the direction of travel of the vehicle. In addition, the light may be emitted so that a specific position is defined.

When the vehicle enters the specific position, the light entering the light sensor is blocked by the vehicle, so that the entry of the vehicle may be recognized. Meanwhile, when the vehicle passes through the specific position, the light blocking by the vehicle is stopped, and the light is detected by the light sensor, so that passage of the vehicle may be recognized.

Referring to FIGS. 1 and 2, the vehicle position detection device 120 may include a first light sensor 121 that receives light emitted from a first light source 121a and defining the first position P1, a second light sensor 122 that receives light emitted from a second light source 122a and defining the second position P2, a third light sensor 123 that receives light emitted from a third light source 123a and defining the third position P3, a fourth light sensor 124 that receives light emitted from a fourth light source 124a and defining the fourth position P4, and a fifth light sensor 125 that receives light emitted from a fifth light source 125a and defining the fifth position P5.

At a point in time when the light received by the first light sensor 121 is blocked, the vehicle may be considered to have entered the first position P1. In addition, at a point in time when the first light sensor 121 receives the light that has been blocked again, the vehicle may be considered to have passed the first position P1.

At a point in time when the light received by the second light sensor 122 is blocked, the vehicle may be considered to have entered the second position P2. In addition, at a point in time when the second light sensor 122 receives the light that has been blocked again, the vehicle may be considered to have passed the second position P2.

At a point in time when the light received by the third light sensor 123 is blocked, the vehicle may be considered to have entered the third position P3. In addition, at a point in time when the third light sensor 123 receives the light that has been blocked again, the vehicle may be considered to have passed the third position P3.

At a point in time when the light received by the fourth light sensor 124 is blocked, the vehicle may be considered to have entered the fourth position P4. In addition, at a point in time when the fourth light sensor 124 receives the light that has been blocked again, the vehicle may be considered to have passed the fourth position P4.

At a point in time when the light received by the fifth light sensor 125 is blocked, the vehicle may be considered to have entered the fifth position P5. In addition, at a point in time when the fifth light sensor 125 receives the light that has been blocked again, the vehicle may be considered to have passed the fifth position P5.

The left photographing device 130 is disposed on the left support portion 111 and photographs the vehicle. The left photographing device 130 may include a plurality of cameras. The left photographing device 130 may capture a left front image of the vehicle, a front left side image of the vehicle, a rear left side image of the vehicle, or a left rear image of the vehicle.

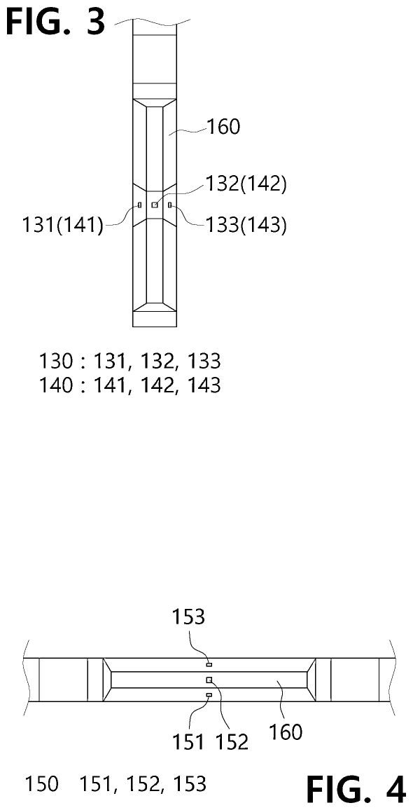

FIG. 3 is a view illustrating a left photographing device or a right photographing device of a support structure of a vehicle exterior scanning system according to one embodiment of the present disclosure.

Referring to FIG. 3, a left photographing device 130 may include a first left camera 131 disposed to face a front left side based on the support structure 110, a second left camera 132 disposed to face the right support portion 112, and a third left camera 133 disposed to face a rear left side based on the support structure 110.

For example, the first left camera 131 may capture a left front image of the vehicle. In addition, the second left camera 132 may capture a front left side image of the vehicle and a rear left side image of the vehicle. In addition, the third left camera 133 may capture a left rear image of the vehicle.

A right photographing device 140 is disposed on the right support portion 112 to photograph the vehicle. The right photographing device 140 may include a plurality of cameras. The right photographing device 140 may capture a right front image of the vehicle, a front right side image of the vehicle, a rear right side image of the vehicle, or a right rear image of the vehicle.

Referring to FIG. 3, the right photographing device 140 may include a first right camera 141 disposed to face a front right side based on the support structure 110, a second right camera 142 disposed to face the left support portion 111, and a third right camera 143 disposed to face a rear right side based on the support structure 110.

For example, the first right camera 141 may capture a right front image of the vehicle. In addition, the second right camera 142 may capture the front right side image of the vehicle and the rear right side image of the vehicle. In addition, the third right camera 143 may capture the right rear image of the vehicle.

The upper photographing device 150 is disposed on the upper support portion 113 to photograph the vehicle. The upper photographing device 150 may include a plurality of cameras.

The upper photographing device 150 may capture a front image of the vehicle, a front upper image of the vehicle, a middle upper image of the vehicle, a rear upper image of the vehicle, or a rear image of the vehicle.

FIG. 4 is a view illustrating an upper photographing device of a support structure of a vehicle exterior scanning system according to one embodiment of the present disclosure.

Referring to FIG. 4, an upper photographing device 150 may include a first upper camera 151 disposed to face a front lower side based on the support structure 110, a second upper camera 152 disposed to face a vertical lower side, and a third upper camera 153 disposed to face a rear lower side based on the support structure 110.

For example, the first upper camera 151 may capture a front image of the vehicle and a front upper image of the vehicle. In addition, the second upper camera 152 may capture a middle upper image of the vehicle. In addition, the third upper camera 153 may capture a rear upper image of the vehicle and a rear image of the vehicle.

A lighting device 160 is disposed on the support structure 110 to emit lighting light. The lighting light emitted by the lighting device 160 allows a vehicle exterior image with a constant illuminance to be acquired regardless of the disposition environment or operating point in time of the vehicle exterior scanning system 100.

A portion of the lighting device 160 disposed on the left support portion 111 may emit lighting light having three different orientations corresponding to the orientations of the first left camera 131, the second left camera 132, and the third left camera 133.

A portion of the lighting device 160 disposed on the right support portion 112 may emit lighting light having three different orientations corresponding to the orientations of the first right camera 141, the second right camera 142, and the third right camera 143.

A portion of the lighting device 160 disposed on the upper support portion 113 may emit lighting light having three different orientations corresponding to the orientations of the first upper camera 151, the second upper camera 152, and the third upper camera 153.

The vehicle number recognition device 170 recognizes the vehicle number written on the license plate of the vehicle. The vehicle number recognition device 170 may photograph the license plate of the vehicle and extract and recognize the vehicle number from an image of the photographed license plate. The vehicle number recognized by the vehicle number recognition device 170 may be used as identification information for identifying the vehicle in the vehicle exterior scanning system 100 according to one embodiment of the present disclosure.

The controller 180 controls the left photographing device 130, the right photographing device 140, or the upper photographing device 150 based on the detection information from the vehicle position detection device 120 to acquire a plurality of vehicle exterior images.

The controller 180 may analyze the plurality of vehicle exterior images to determine whether the exterior of the vehicle is damaged. The controller 180 may analyze the plurality of vehicle exterior images using an artificial intelligence model (e.g., an artificial neural network model) or an image reading algorithm. The controller 180 may determine whether the exterior of the vehicle is damaged based on analysis results.

The controller 180 may be connected to the vehicle position detection device 120, the left photographing device 130, the right photographing device 140, or the upper photographing device 150 via wires or wirelessly. In addition, the controller 180 may be connected to the lighting device 160 or the vehicle number recognition device 170 via wires or wirelessly.

The controller 180 may be a computer device including a memory and a processor.

The memory may include storage media such as a read only memory (ROM), a random-access memory (RAM), a flash memory, or the like. Further, the memory may include a hardware device configured to store and execute program instructions, such as magnetic media such as floppy disks and magnetic tapes, optical recording media such as compact disk read-only memory (CD-ROM) and digital video disks (DVD), magneto-optical media such as floptical disks, or the like.

The processor may be a hardware unit that performs calculations and control. The processor may include at least one arithmetic logic unit (ALU) and a register.

The controller 180 determines the position of the vehicle based on detection information from the vehicle position detection device 120 while the vehicle enters the support structure 110 from the front of the support structure 110 and exits the rear of the support structure 110.

The controller 180 may operate the left photographing device 130 according to the position of the vehicle to acquire a left front image of the vehicle, a front left side image of the vehicle, a rear left side image of the vehicle, or a left rear image of the vehicle.

The controller 180 may operate the right photographing device 140 according to the position of the vehicle to acquire a right front image of the vehicle, a front right side image of the vehicle, a rear right side image of the vehicle, or a right rear image of the vehicle.

The controller 180 may operate the upper photographing device 150 according to the position of the vehicle to acquire the front upper image of the vehicle or the rear upper image of the vehicle. In addition, the controller 180 may operate the upper photographing device 150 according to the position of the vehicle to further acquire a front image of the vehicle and the rear image of the vehicle. In addition, the controller 180 may operate the upper photographing device 150 according to the position of the vehicle to further acquire a middle upper image of the vehicle.

The controller 180 may operate one or more of the left photographing device 130, the right photographing device 140, or the upper photographing device 150 at a point in time when it is determined that the vehicle reaches each of the first position P1, the second position P2, the third position P3, the fourth position P4, or the fifth position P5 based on the detection information from the vehicle position detection device 120.

The controller 180 may operate one or more of the left photographing device 130, the right photographing device 140, or the upper photographing device 150 at a point in time when it is determined that the vehicle passes each of the first position P1, the second position P2, the third position P3, the fourth position P4, or the fifth position P5 based on the detection information from the vehicle position detection device 120.

Hereinafter, a process of acquiring vehicle exterior images by the vehicle exterior scanning system 100 according to one embodiment of the present disclosure will be examined in detail.

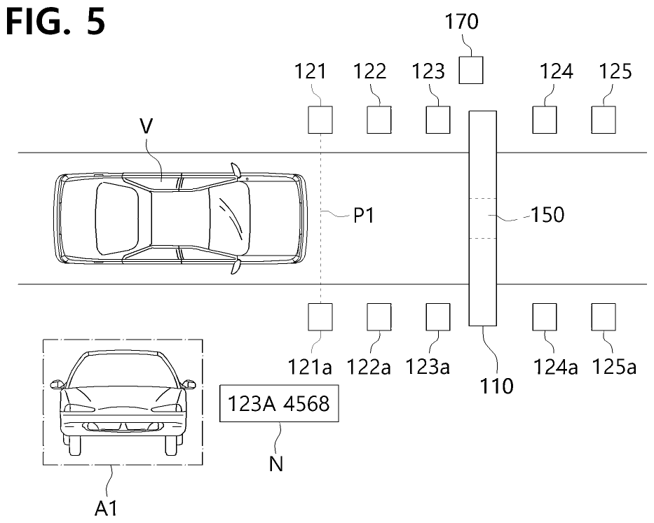

FIG. 5 is a view illustrating acquisition of a vehicle front image by the vehicle exterior scanning system according to one embodiment of the present disclosure.

Referring to FIG. 5, the vehicle exterior scanning system 100 detects entry of a vehicle V when the vehicle V reaches a first position P1 separated in front of the support structure 110. The vehicle exterior scanning system 100 acquires a front image A1 of the vehicle V at a point in time when when the vehicle V reaches the first position P1 separated in front of the support structure 110.

When the controller 180 determines that the vehicle V enters the first position P1 based on detection information from the first light sensor 121, the controller operates the upper photographing device 150 to acquire the front image A1 of the vehicle V. For example, the controller 180 may operate the first upper camera 151 to acquire the front image A1 of the vehicle V.

At this time, the vehicle number recognition device 170 may recognize a vehicle number N written on the license plate of the vehicle V. The vehicle number N recognized by the vehicle number recognition device 170 is transmitted to the controller 180, and the controller 180 may use the vehicle number N as identification information for identifying different vehicles.

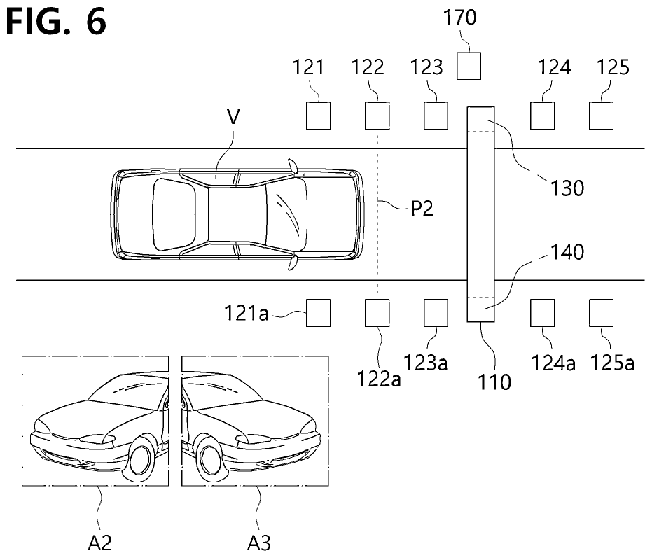

FIG. 6 is a view illustrating acquisition of a vehicle left front image and a vehicle right front image by the vehicle exterior scanning system according to one embodiment of the present disclosure.

Referring to FIG. 6, the vehicle exterior scanning system 100 acquires a left front image A2 and a right front image A3 of the vehicle V at a point in time when the vehicle V reaches a second position P2 between the first position P1 and the support structure 110. For example, the controller 180 may operate the first left camera 131 and the first right camera 141 to acquire the left front image A2 and the right front image A3 of the vehicle V.

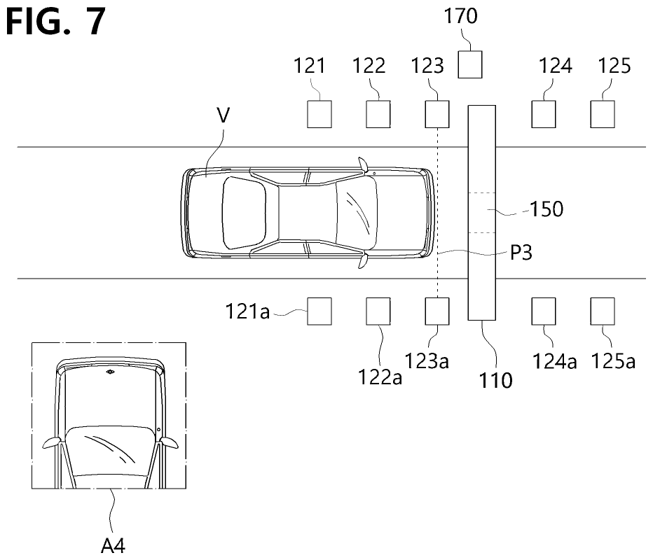

FIG. 7 is a view illustrating acquisition of a vehicle front upper image by the vehicle exterior scanning system according to one embodiment of the present disclosure.

Referring to FIG. 7, the vehicle exterior scanning system 100 acquires a front upper image A4 of the vehicle V at a point in time when the vehicle V reaches a third position P3 between the second position P2 and the support structure 110. For example, the controller 180 may operate the first upper camera 151 or the second upper camera 152 to acquire the front upper image A4 of the vehicle V.

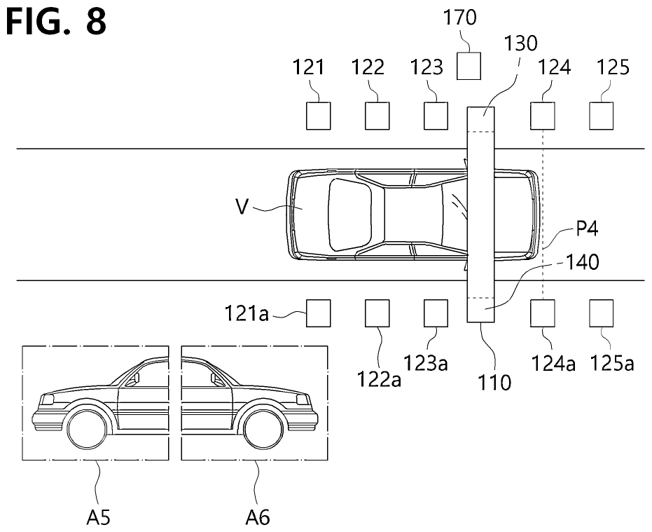

FIG. 8 is a view illustrating acquisition of a vehicle front left side image and a vehicle front right side image by the vehicle exterior scanning system according to one embodiment of the present disclosure.

Referring to FIG. 8, the vehicle exterior scanning system 100 acquires a front left side image A5 of the vehicle V and a front right side image A6 of the vehicle V at a point in time when the vehicle V reaches a fourth position P4 separated in the rear of the support structure 110. For example, the controller 180 may operate the second left camera 132 and the second right camera 142 to acquire the front left side image A5 of the vehicle V and the front right side image A6 of the vehicle V.

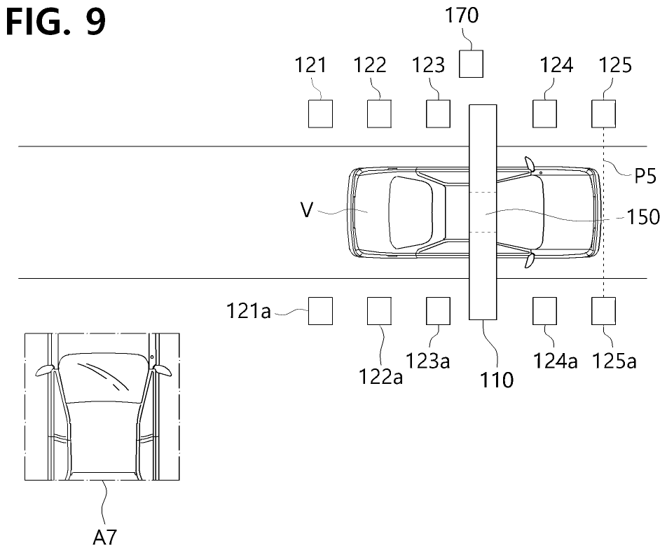

FIG. 9 is a view illustrating acquisition of a vehicle middle upper image by the vehicle exterior scanning system according to one embodiment of the present disclosure.

Referring to FIG. 9, the vehicle exterior scanning system 100 acquires a middle upper image A7 of the vehicle V at a point in time when the vehicle V reaches a fifth position P5 separated further rearward from the support structure 110 than the fourth position P4. For example, the controller 180 may operate the second upper camera 152 to acquire the middle upper image A7 of the vehicle V.

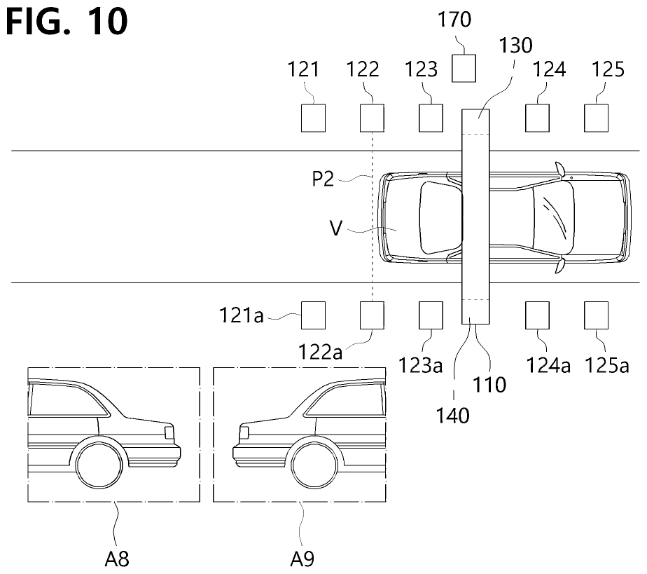

FIG. 10 is a view illustrating acquisition of a vehicle rear left side image and a vehicle rear right side image by the vehicle exterior scanning system according to one embodiment of the present disclosure.

Referring to FIG. 10, the vehicle exterior scanning system 100 acquires a rear left side image A8 of the vehicle V and a rear right side image A9 of the vehicle V at a point in time when the vehicle V passes the second position P2. For example, the controller 180 may operate the second left camera 132 and the second right camera 142 to acquire the rear left side image A8 of the vehicle V and the rear right side image A9 of the vehicle V.

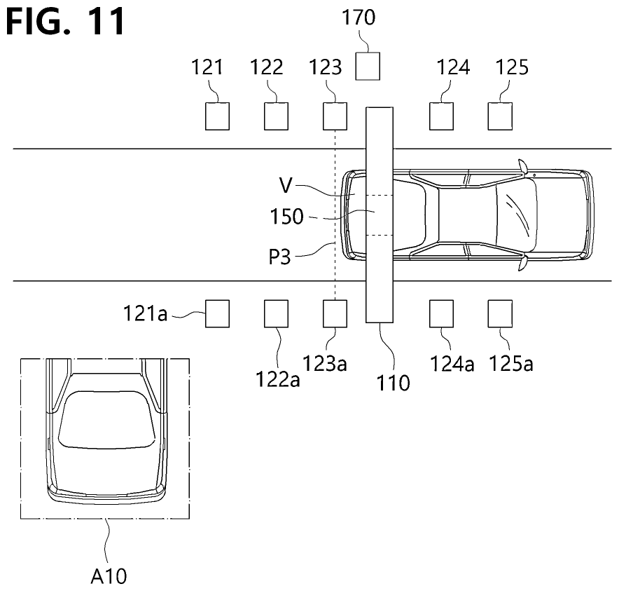

FIG. 11 is a view illustrating acquisition of a vehicle rear upper image by the vehicle exterior scanning system according to one embodiment of the present disclosure.

Referring to FIG. 11, the vehicle exterior scanning system 100 acquires a rear upper image A10 of the vehicle V at a point in time when the vehicle V passes the third position P3. For example, the controller 180 may operate the second upper camera 152 or the third upper camera 153 to acquire the rear upper image A10 of the vehicle V.

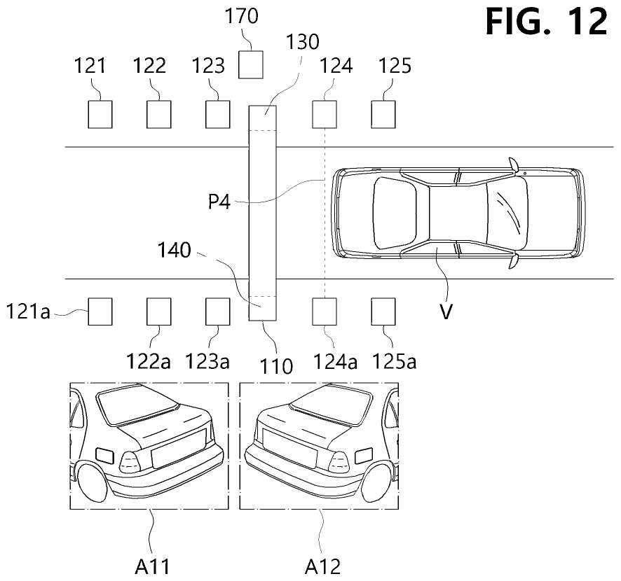

FIG. 12 is a view illustrating acquisition of a vehicle left rear image and a vehicle right rear image by the vehicle exterior scanning system according to one embodiment of the present disclosure.

Referring to FIG. 12, the vehicle exterior scanning system 100 acquires a rear left side image A11 of the vehicle V and a rear right side image A12 of the vehicle V at a point in time when the vehicle V passes a fourth position P4. For example, the controller 180 may operate the third left camera 133 and the third right camera 143 to acquire the rear left side image A11 of the vehicle V and the rear right side image A12 of the vehicle V.

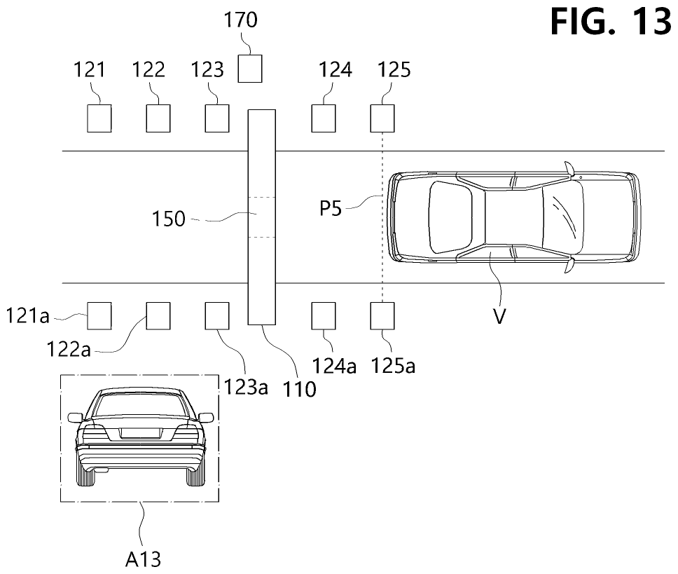

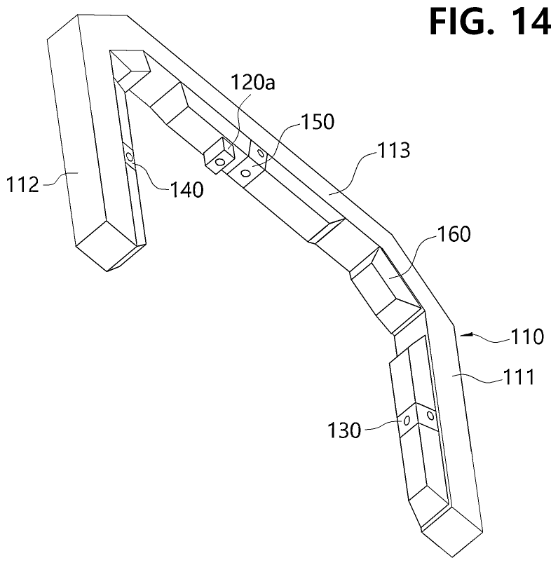

FIG. 13 is a view illustrating acquisition of a vehicle rear image by the vehicle exterior scanning system according to one embodiment of the present disclosure.

Referring to FIG. 13, the vehicle exterior scanning system 100 acquires a rear image A13 of a vehicle V at a point in time when the vehicle V passes the fifth position P5. For example, the controller 180 may operate the third upper camera 153 to acquire the rear image A13 of the vehicle V.

In the above, the process of acquiring a plurality of vehicle exterior images by the vehicle exterior scanning system 100 according to one embodiment of the present disclosure has been described in detail.

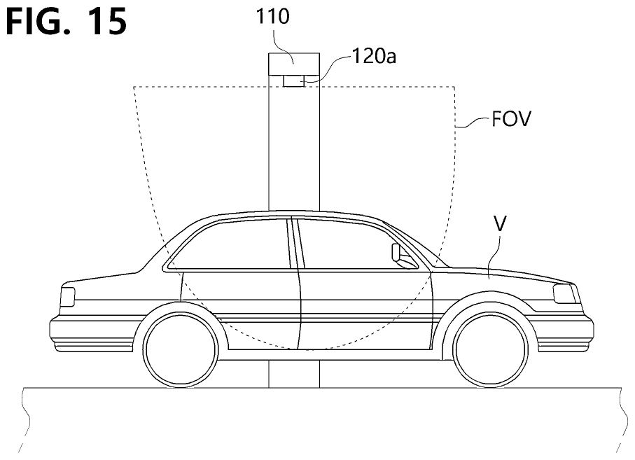

FIG. 14 is a view illustrating another example of a vehicle position detection device of a vehicle exterior scanning system according to one embodiment of the present disclosure.

Referring to FIG. 14, a vehicle position detection device 120 may include a lidar sensor 120a. The lidar sensor 120a may be disposed on the upper support portion 113 of the support structure 110. The lidar sensor 120a may be disposed by replacing the first to fifth light sensors 121, 122, 123, 124, and 125.

FIG. 15 illustrates a state in which vehicle position detection is performed when the vehicle position detection device of the vehicle exterior scanning system according to one embodiment of the present disclosure is configured as shown in FIG. 14.

Referring to FIG. 15, the lidar sensor 120a may have a detection area (field of view (FOV) that spans the front and rear of the support structure 110 to detect a vehicle V existing within the field of view FOV. More specifically, the lidar sensor 120a may detect the position of the vehicle V within a certain area in front of and in the rear of the support structure 110.

For example, a plurality of positions are set across the front and rear of the support structure 110 within the field of view of the lidar sensor 120a, and based on the image acquired by the lidar sensor 120a, it may be determined whether the vehicle V enters a specific position among the plurality of positions or passes through a specific position.

In the following, a method S100 of scanning the exterior of a vehicle according to one embodiment of the present disclosure will be described.

The method S100 of scanning the exterior of a vehicle according to one embodiment of the present disclosure may be performed by the vehicle exterior scanning system 100 according to one embodiment of the present disclosure.

The method S100 of scanning the exterior of a vehicle automatically acquires a plurality of vehicle exterior images that allow determination as to whether the exterior of the vehicle is damaged to be made. In addition, the method S100 of scanning the exterior of a vehicle may determine whether the exterior of the vehicle is damaged using the plurality of vehicle exterior images.

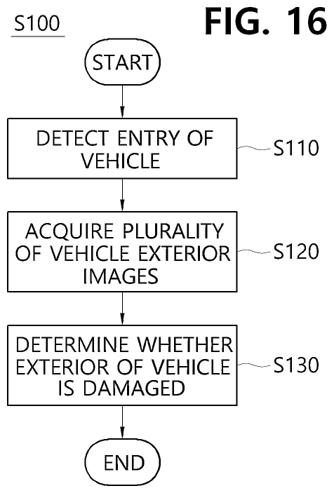

FIG. 16 is a flowchart of a method of scanning the exterior of a vehicle according to one embodiment of the present disclosure.

Referring to FIG. 16, the method S100 of scanning the exterior of a vehicle may be performed as follows.

First, the vehicle that enters a position separated in front of the support structure 110 is detected (S110). The controller 180 may recognize entry of the vehicle based on detection information from the vehicle position detection device 120.

For example, the controller 180 may recognize entry of the vehicle when the vehicle enters the first position P1 based on detection information from the vehicle position detection device 120 and prepare an operation for acquiring exterior images of the vehicle.

Next, while the vehicle is moving by entering the front of the support structure 110 and exiting the rear, a plurality of vehicle exterior images are acquired (S120).

Finally, the plurality of vehicle exterior images are analyzed to determine whether the exterior of the vehicle is damaged (S130). The controller 180 may analyze the plurality of vehicle exterior images to determine whether the exterior of the vehicle is damaged.

The controller 180 may analyze the plurality of vehicle exterior images using an artificial intelligence model (e.g., an artificial neural network model) or an image reading algorithm, and determine whether the exterior of the vehicle is damaged based on analysis results.

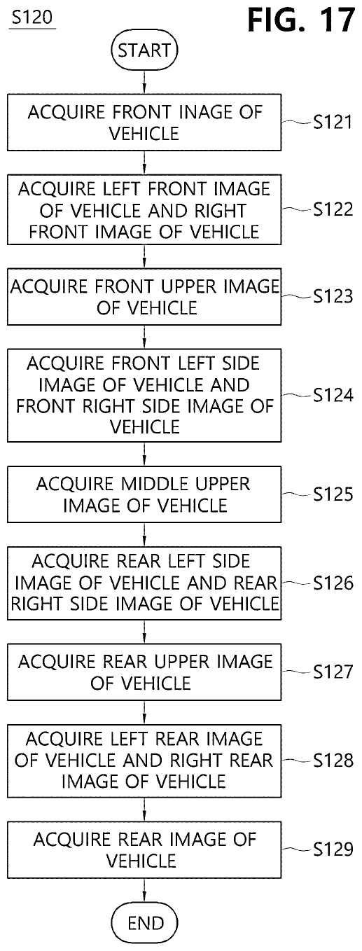

FIG. 17 is a flowchart of the operation of acquiring a plurality of vehicle exterior images in the method of scanning the exterior of a vehicle according to one embodiment of the present disclosure.

Referring to FIG. 17, the operation S120 of acquiring a plurality of vehicle exterior images in the method S100 of scanning the exterior of a vehicle may be performed as follows.

First, when the vehicle reaches the first position P1 separated in front of the support structure 110, a front image of the vehicle is acquired (S121).

The vehicle exterior scanning system 100 acquires the front image A1 of the vehicle V at the point in time when the vehicle V reaches the first position P1 separated in front of the support structure 110. More specifically, when the controller 180 determines that the vehicle V enters the first position P1 based on detection results of the vehicle position detection device 120, the controller 180 may operate the upper photographing device 150 to acquire the front image A1 of the vehicle V.

At this time, the vehicle number recognition device 170 may recognize the vehicle number N written on the license plate of the vehicle V. The vehicle number N recognized by the vehicle number recognition device 170 is transmitted to the controller 180, and the controller 180 may use the vehicle number N as identification information for identifying different vehicles.

Next, at a point in time when the vehicle reaches the second position P2 between the first position P1 and the support structure 110, a left front image of the vehicle and a right front image of the vehicle are acquired (S122).

The vehicle exterior scanning system 100 acquires the left front image A2 and the right front image A3 of the vehicle V at the point in time when the vehicle V reaches the second position P2 between the first position P1 and the support structure 110. More specifically, the controller 180 may operate the left photographing device 130 or the right photographing device 140 based on the detection results of the vehicle position detection device 120 to acquire the left front image A2 and the right front image A3 of the vehicle V.

Next, at a point in time when the vehicle reaches the third position P3 between the second position P2 and the support structure 110, an upper front image of the vehicle is acquired (S123).

The vehicle exterior scanning system 100 acquires the front upper image A4 of the vehicle V at the point in time when the vehicle V reaches the third position P3 between the second position P2 and the support structure 110. For example, the controller 180 may operate the upper photographing device 150 based on the detection results of the vehicle position detection device 120 to acquire the front upper image A4 of the vehicle V.

Next, at a point in time when the vehicle reaches the fourth position P4 separated in the rear of the support structure 110, a front left side image of the vehicle and a front right side image of the vehicle are acquired (S124).

The vehicle exterior scanning system 100 acquires the front left side image A5 of the vehicle V and the front right side image A6 of the vehicle V at the point in time when the vehicle V reaches a fourth position P4 separated in the rear of the support structure 110. More specifically, the controller 180 may operate the left photographing device 130 or the right photographing device 140 based on the detection results of the vehicle position detection device 120 to acquire the front left side image A5 of the vehicle V and the front right side image A6 of the vehicle V.

Next, at a point in time when the vehicle reaches the fifth position P5 separated further rearward from the support structure 110 than the fourth position P4, a middle upper image of the vehicle is acquired (S125).

The vehicle exterior scanning system 100 acquires the middle upper image A7 of the vehicle V at the point in time when the vehicle V reaches the fifth position P5 separated from the support structure 110 further rearward than the fourth position P4. More specifically, the controller 180 may operate the upper photographing device 150 based on the detection results of the vehicle position detection device 120 to acquire the middle upper image A7 of the vehicle V.

Next, at a point in time when the vehicle passes the second position P2, a rear left side image of the vehicle and a rear right side image of the vehicle are acquired (S126).

The vehicle exterior scanning system 100 acquires the rear left side image A8 of the vehicle V and the rear right side image A9 of the vehicle V at the point in time when the vehicle V passes the second position P2. More specifically, the controller 180 may operate the left photographing device 130 or the right photographing device 140 based on the detection results of the vehicle position detection device 120 to acquire the rear left side image A8 of the vehicle V and the rear right side image A9 of the vehicle V.

Next, at a point in time when the vehicle passes the third position P3, a rear upper image of the vehicle is acquired (S127).

The vehicle exterior scanning system 100 acquires the rear upper image A10 of the vehicle V at the point in time when the vehicle V passes the third position P3. More specifically, the controller 180 may operate the upper photographing device 150 based on the detection results of the vehicle position detection device 120 to acquire the rear upper image A10 of the vehicle V.

Next, at a point in time when the vehicle passes the fourth position P4, a rear left side image of the vehicle and a rear right side image of the vehicle are acquired (S128).

The vehicle exterior scanning system 100 acquires the rear left side image A11 of the vehicle V and the rear right side image A12 of the vehicle V at the point in time when the vehicle V passes the fourth position P4. More specifically, the controller 180 may operate the left photographing device 130 or the right photographing device 140 based on the detection results of the vehicle position detection device 120 to acquire the rear left side image A11 of the vehicle V and the rear right side image A12 of the vehicle V.

Finally, at a point in time when the vehicle passes the fifth position P5, a rear image of the vehicle is acquired (S129).

The vehicle exterior scanning system 100 acquires the rear image A13 of the vehicle V at the point in time when the vehicle V passes the fifth position P5. More specifically, the controller 180 may operate the upper photographing device 150 based on the detection results of the vehicle position detection device 120 to acquire the rear image A13 of the vehicle V.

Meanwhile, the present disclosure additionally provides a non-transitory computer-readable storage medium storing a program for performing the method S100 of scanning the exterior of a vehicle. Specifically, the present disclosure may provide a non-transitory computer-readable storage medium storing a program including at least one instruction for performing the method S100 of scanning the exterior of a vehicle.

In this case, the instruction may include not only machine code generated by a compiler but also high-level language code executable by the computer.

The storage medium may include a hardware device configured to store and execute program instructions, such as magnetic media such as hard disks, floppy disks, and magnetic tapes, optical recording media such as compact disk read-only memory (CD-ROM) and digital video disks (DVD), magneto-optical media such as floptical disks, ROM, RAM, flash memory, or the like.

According to the configuration, a system and method for scanning the exterior of a vehicle according to one aspect of the present disclosure, and a computer-readable storage medium storing a program for performing the method automatically acquire a plurality of vehicle exterior images through a plurality of photographing devices during a process in which a vehicle enters the front of a support structure and exits the rear.

A system and method for scanning the exterior of a vehicle according to one aspect of the present disclosure, and a computer-readable storage medium storing a program for performing the method automatically determine whether the exterior of a vehicle is damaged when the vehicle enters the front of a support structure and exits the rear.

It should be understood that the effects of the present disclosure are not limited to the above-described effects and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A system for scanning an exterior of a vehicle, comprising:
a support structure that is disposed so that the vehicle enters a front thereof and exits a rear thereof and that includes a left support portion vertically extending on a left side based on a direction of travel of the vehicle, a right support portion vertically extending on a right side based on the direction of travel of the vehicle, and an upper support portion supported by the left support portion and the right support portion on an upper side of the vehicle and extending in a left-right direction;
a vehicle position detection device including one or more sensors for detecting a position of the vehicle entering the front of the support structure or exiting the rear of the support structure;
a left photographing device disposed on the left support portion to photograph the vehicle;
a right photographing device disposed on the right support portion to photograph the vehicle;
an upper photographing device disposed on the upper support portion to photograph the vehicle; and
a controller configured to control the left photographing device, the right photographing device, and the upper photographing device based on detection information from the vehicle position detection device to acquire a plurality of vehicle exterior images.

2. The system of claim 1, wherein the controller determines whether the exterior of the vehicle is damaged by analyzing the plurality of vehicle exterior images.

3. The system of claim 1, wherein the left photographing device includes a first left camera disposed to face a front left side based on the support structure, a second left camera disposed to face the right support portion, and a third left camera disposed to face a rear left side based on the support structure.

4. The system of claim 1, wherein the right photographing device includes a first right camera disposed to face a front right side based on the support structure, a second right camera disposed to face the left support portion, and a third right camera disposed to face a rear right side based on the support structure.

5. The system of claim 1, wherein the upper photographing device includes a first upper camera disposed to face a front lower side based on the support structure, a second upper camera disposed to face a vertical lower side, and a third upper camera disposed to face a rear lower side based on the support structure.

6. The system of claim 1, wherein the controller is configured to:
determine the position of the vehicle based on the detection information from the vehicle position detection device while the vehicle enters the support structure from the front of the support structure and exits the rear of the support structure; and
operate the left photographing device depending on the position of the vehicle to acquire a left front image of the vehicle, a front left side image of the vehicle, a rear left side image of the vehicle, or a left rear image of the vehicle.

7. The system of claim 1, wherein the controller is configured to:
determine the position of the vehicle based on the detection information from the vehicle position detection device while the vehicle enters the support structure from the front of the support structure and exits the rear of the support structure; and
operate the right photographing device depending on the position of the vehicle to acquire a right front image of the vehicle, a front right side image of the vehicle, a rear right side image of the vehicle, or a right rear image of the vehicle.

8. The system of claim 1, wherein the controller is configured to:
determine the position of the vehicle based on the detection information from the vehicle position detection device while the vehicle enters the support structure from the front of the support structure and exits the rear of the support structure; and
operate the upper photographing device depending on the position of the vehicle to acquire a front upper image of the vehicle or a rear upper image of the vehicle.

9. The system of claim 8, wherein the controller operates the upper photographing device depending on the position of the vehicle to further acquire a front image of the vehicle or a rear image of the vehicle.

10. The system of claim 9, wherein the controller operates the upper photographing device depending on the position of the vehicle to further acquire a middle upper image of the vehicle.

11. The system of claim 1, wherein the vehicle position detection device includes a light sensor configured to detect emitted light.

12. The system of claim 1, wherein the vehicle position detection device includes a lidar sensor disposed on the upper support portion of the support structure.

13. The system of claim 1, wherein the controller operates one or more of the left photographing device, the right photographing device, or the upper photographing device at a point in time when it is determined that the vehicle reaches each of a first position where the vehicle is separated in front of the support structure, a second position between the first position and the support structure, a third position between the second position and the support structure, a fourth position separated in the rear of the support structure, or a fifth position separated further rearward from the support structure than the fourth position based on the detection information from the vehicle position detection device.

14. The system of claim 1, wherein the controller operates one or more of the left photographing device, the right photographing device, or the upper photographing device at a point in time when it is determined that the vehicle passes each of a first position separated in front of the support structure, a second position between the first position and the support structure, a third position between the second position and the support structure, a fourth position separated in the rear of the support structure, or a fifth position separated further rearward from the support structure than the fourth position based on the detection information from the vehicle position detection device.

15. The system of claim 1, further comprising one or more lighting devices disposed on the support structure to emit lighting light.

16. The system of claim 1, further comprising a vehicle number recognition device configured to recognize a vehicle number written on a license plate of the vehicle.

17. A method of scanning an exterior of a vehicle, comprising:
detecting a vehicle entering a position separated in front of a support structure;
acquiring a plurality of vehicle exterior images while the vehicle proceeds by entering a front of the support structure and exiting a rear; and
determining whether the exterior of the vehicle is damaged by analyzing the plurality of vehicle exterior images.

18. The method of claim 17, wherein the acquiring of the plurality of vehicle exterior images includes:
acquiring a front image of the vehicle at a point in time when the vehicle reaches a first position separated in front of the support structure;
acquiring a left front image of the vehicle and a right front image of the vehicle at a point in time when the vehicle reaches a second position between the first position and the support structure;
acquiring a front upper image of the vehicle at a point in time when the vehicle reaches a third position between the second position and the support structure;
acquiring a front left side image of the vehicle and a front right side image of the vehicle at a point in time when the vehicle reaches a fourth position separated in the rear of the support structure; and
acquiring a middle upper image of the vehicle at a point in time when the vehicle reaches a fifth position separated further rearward from the support structure than the fourth position.

19. The method of claim 18, wherein the acquiring of the plurality of vehicle exterior images further includes:
acquiring a rear left side image of the vehicle and a rear right side image of the vehicle at a point in time when the vehicle passes the second position;
acquiring a rear upper image of the vehicle at a point in time when the vehicle passes the third position;
acquiring a rear left side image of the vehicle and a rear right side image of the vehicle at a point in time when the vehicle passes the fourth position; and
acquiring a rear image of the vehicle at a point in time when the vehicle passes the fifth position.

20. A non-transitory computer-readable storage medium storing one or more instructions for performing a method of scanning an exterior of a vehicle, the method comprising:
detecting a vehicle entering a position separated in front of a support structure;
acquiring a plurality of vehicle exterior images while the vehicle proceeds by entering a front of the support structure and exiting a rear; and
determining whether the exterior of the vehicle is damaged by analyzing the plurality of vehicle exterior images.
